(19) United States
(12) Patent Application Publication
(10) Pub. No.: US 2019/0330890 A1
(43) Pub. Date: Oct. 31, 2019

(54) DEPLOYABLE DOOR BARRICADE

(71) Applicant: James Raman, Columbia, SC (US)

(72) Inventor: James Raman, Columbia, SC (US)

(21) Appl. No.: 15/963,321

(22) Filed: Apr. 26, 2018

(51) Int. Cl. E05C 19/06

(52) U.S. Cl. CPC E05C 19/06

(57) ABSTRACT

A low-profile door barricade can be deployed rapidly from within a room, such as a classroom, to prevent entry by an assailant. The barricade may include quick release and locking mechanisms that are inaccessible to the assailant and can only be operated from within the room.

### BACKGROUND

Regrettably, armed intrusions into schools, offices, homes, and the like by violent aggressors have increased in recent years. Some universities, for instance, have posted emergency procedures around their campuses that advise running and hiding from an armed intruder, or fighting as a last resort. The last resort—fighting—includes instructions to throw things at the intruder. One school district, for example, recently furnished its classrooms with buckets of rocks under the theory that if an armed intruder attempts to gain entrance into a classroom, the intruder will be stoned by the students. Peggy Lee, Superintendent Says Students Are Armed with Rocks In Case of a School Shooting, Newswatch 16, WNEP, Mar. 23, 2018, at http://wnep.com/2018/03/22/superintendent-says-students-are-armed-with-rocks-in-case-of-a-school-shooting/. Another school district, which does not wish to train and arm school personnel with firearms, instead distributed hundreds of miniature baseball bats to its teachers to fight back against school shooters. Tribune Media Wire, WGN 9 Chicago, Pennsylvania School District Hands Out Baseball Bats For Classroom Defense, Apr. 11, 2018, at http://wgntv.com/2018/04/11/school-district-hands-out-baseball-bats-for-classroom-defense/.

Rather than facing an armed intruder with miniature bats, or throwing rocks and things at a shooter, it would be best at the outset if the intruder could not enter a class of unarmed students. Unfortunately, conventional door locks can be shot and broken. Other known door blocking devices require complex installation or activation, or there are needed components that are stored separately from a door, which might not be located and installed in a panic when seconds count.

What is needed in schools, office buildings, homes, and the like is a door barricade system that can be actuated within seconds without having to search for and install component parts, that cannot be seen by an intruder from an opposite side of the door, and that can hold the door securely closed even if a door handle, knob, or lock is destroyed by the intruder.

### BRIEF SUMMARY OF THE DISCLOSURE

The present disclosure provides door barricade systems that can be actuated or deployed within seconds in the event that a violent intruder enters a school, an office building, homes, or the like. The low-profile barricade systems are installed generally at or around the base of a door, and there are no loose or separate component parts such as a bar, that must be retrieved from a closet or storage area before the part can be installed on the door. Moreover, the deployable door barricades cannot be seen easily by an intruder from an opposite side of the door. Even if the intruder shoots the door knob and lock, the door barricade system will securely hold the door closed. In most cases, if the intruder cannot gain entry within a few seconds, the intruder will move on and provide authorities with additional time to respond.

According to one embodiment of the disclosure, a door barricade system may include a mounting plate connectable to a door; a first leg having a first proximal end and a first distal end, the first proximal end being connectable to and rotatable relative to the mounting plate, the first leg being configured for a stored state, a transitioning state, and a deployed state; a second leg having a second proximal end and a second distal end, the second proximal end being rotatably connected to first distal end of the first leg, the second leg being configured to be in the stored state, the transitioning state, and the deployed state; a third leg having a third proximal end and a third distal end, the third proximal end being connectable to and rotatable relative to the mounting plate, the third distal end being rotatably connected to second distal end of the second leg, the third leg being configured to be in the stored state, the transitioning state, and the deployed state; and a non-skid stand attached to the third leg, the non-skid stand being engaged against a surface proximate the door when the first, second and third legs are in the deployed state, the first leg and the second leg being lockable against each other proximate a ledge disposed on the second leg and further configured to press the non-skid stand into the surface as a force is applied against the door.

Also in this embodiment, the mounting plate, the first leg, the second leg, the third leg and the non-skid stand, when in the stored state, define a compact profile such as from between about 2 inches to about 6 inches from the door. Also, the mounting plate may be mounted to the door at a minimum height above the surface such as from between about 3 inches to about 6 inches between a bottom of the mounting plate and the surface.

The non-skid stand of the exemplary door barricade system may also include a slot therein to receive a portion of the first leg or the second leg. Further, a release mechanism may be included to deploy the first leg, the second leg, the third leg and the non-skid stand in a direction away from the mounting plate.

The door barricade system may further include a friction-inducing cover for the non-skid stand, and a spring attached between the mounting plate and non-skid stand for urging the first leg, the second leg, the third leg and the non-skid stand to remain in the stored state.

The door barricade system may also have a plate for urging the first leg and the second leg to form an obtuse angle in the deployed state. More specifically, the plate may lock the first leg and the second leg in the deployed state, and the locked first and second legs may cooperate with the non-skid stand in the deployed state to oppose an opening of the door.

In another embodiment, a door barricade system may include a first leg having a first proximal end and a first distal end, the first proximal end being connectable to and rotatable relative to a door, the first leg being configured for a stored state, a transitioning state, and a deployed state; a second leg having a second proximal end and a second distal end, the second proximal end being rotatably connected to first distal end of the first leg, the second leg being configured to be in the stored state, the transitioning state, and the deployed state; a third leg having a third proximal end and a third distal end, the third proximal end being connectable to and rotatable relative to the door, the third distal end being rotatably connected to second distal end of the second leg, the third leg being configured to be in the stored state, the transitioning state, and the deployed state; and a non-skid stand attached to the third leg, the non-skid stand having a slot therein to receive a portion of the first leg or the second leg, the non-skid stand being engageable against a surface proximate the door when the first, second and third legs are in the deployed state.

The exemplary door barricade system may also include a release mechanism configured to deploy the first leg, the second leg, the third leg and the non-skid stand in a direction away from the door. The non-skid stand may be substantially aligned with the third leg in the transitioning state and disposed at an angle relative to the third leg in the deployed state.

In the deployed state, as an opening force is applied to the door, the first leg and the second leg may resist or lock against each other and further press the non-skid stand, which may have an elastomeric cover, into the surface.

The door barricade system may also include a spring mechanism attached between the door and the non-skid stand for urging the first leg, the second leg, the third leg and the non-skid stand to remain in the stored state.

The door barricade system may further include a plate for urging the first leg and the second leg to form an obtuse angle in the deployed state, and may also include a mounting base connectable to a door, the mounting base being interposed between the door and the first leg and the third leg.

Additional aspects of the present subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of such variations upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a schematic view of an embodiment of a door barricade system shown in an intended use environment according to the present disclosure;

FIG. 2 is a perspective view of the system as in FIG. 1;

FIG. 3 is an exploded perspective view of another embodiment of a door barricade system according to the present disclosure;

FIG. 4 is a side elevational view of the system as in FIG. 3;

FIG. 5 is the side elevational view as in FIG. 4, particularly showing an exemplary operation of the system;

FIG. 6 is the side elevational view as in FIG. 5, particularly showing further exemplary operation of the system;

FIG. 7 is a perspective view of the system as in FIGS. 5 and 6, particularly showing additional exemplary operation of the system;

FIG. 8 is a side elevational view of the embodiment as in FIG. 7 particularly showing additional exemplary operation of the system in an intended use environment;

FIG. 9 is the side elevational view as in FIG. 8 further showing additional exemplary operation of the system;

FIG. 10 is a perspective view of another embodiment of a door barricade system according to the present disclosure;

FIG. 11 is a left perspective view of another embodiment of a door barricade system according to the present disclosure; and

FIG. 12 is a right perspective view of the embodiment as in FIG. 11.

### DETAILED DESCRIPTION

Detailed reference will now be made to the drawings in which examples embodying the present subject matter are shown. The detailed description uses numerical and letter designations to refer to features of the drawings.

The drawings and detailed description provide a full and written description of the present subject matter, and of the manner and process of making and using various exemplary embodiments, so as to enable one skilled in the pertinent art to make and use them, as well as the best mode of carrying out the exemplary embodiments. However, the examples set forth in the drawings and detailed descriptions are provided by way of explanation only and are not meant as limitations of the disclosure. The present subject matter thus includes any modifications and variations of the following examples as come within the scope of the appended claims and their equivalents.

Although detailed embodiments are disclosed as required, it is to be understood that the embodiments are merely exemplary. The figures are not necessarily to scale, and some features may be exaggerated to show details of particular components. Therefore, specific structural and functional details disclosed herein are not to be interpreted as limiting, but merely as a basis for the claims and as a representative basis for teaching one skilled in the art to variously employ the various embodiments of the present disclosure.

Unless defined otherwise, all technical and scientific terms used herein have the same meaning as is commonly understood by one of ordinary skill in the art to which this disclosure belongs. In the event that there is a plurality of definitions for a term herein, those in this section prevail unless stated otherwise.

Wherever the phrase “for example,” “such as,” “including” and the like are used herein, the phrase “and without limitation” is understood to follow unless explicitly stated otherwise. Similarly “an example,” “exemplary” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etcetera. Thus, for example, “a device having components a, b, and c” means that the device includes at least components a, b and c. Similarly, the phrase: “a method involving steps a, b, and c” means that the method includes at least steps a, b, and c.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Any discussion of prior art in the specification should in no way be considered as an admission that such prior art is widely known or forms part of common general knowledge in the field.

The various embodiments of the disclosure and/or equivalents falling within the scope of present disclosure overcome or ameliorate at least one of the disadvantages of the prior art, or provide a useful alternative.

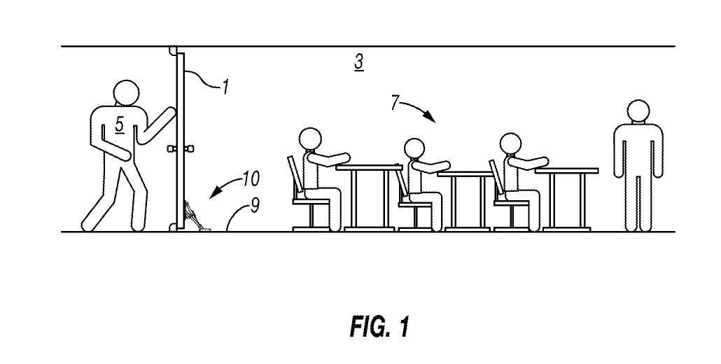

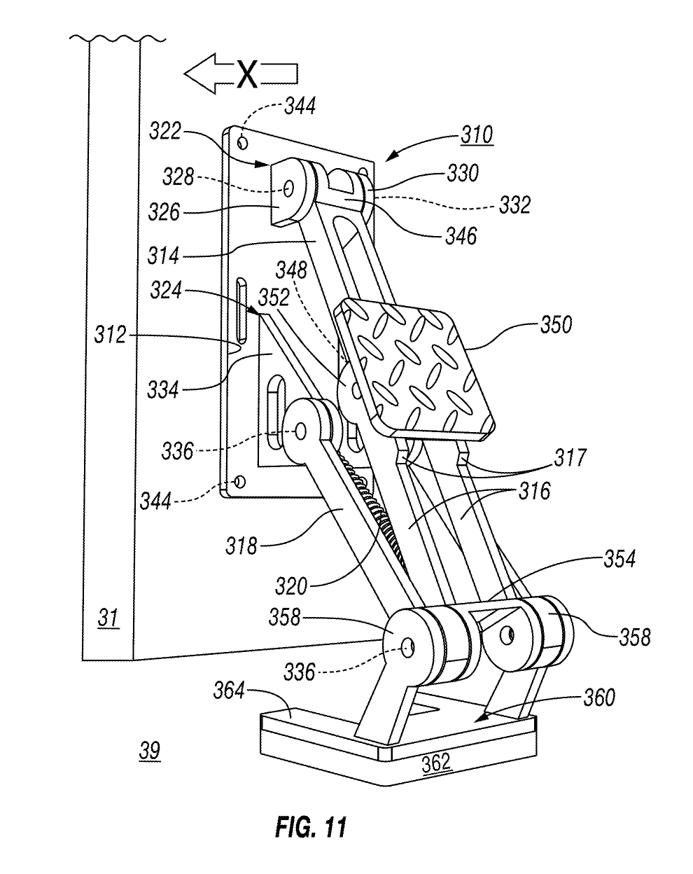

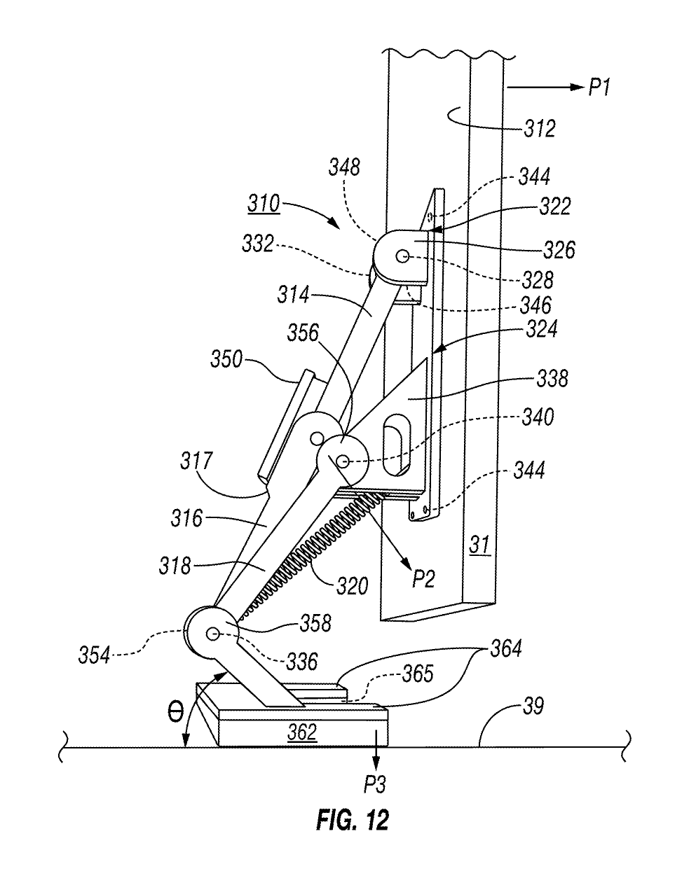

Turning now to the figures, FIG. 1 shows a door 1 that opens into a room, such as a classroom 3. As shown, an intruder 5 is unable to open the door 1 to gain access to people, such as a teacher and students 7 in the classroom 3. Entry by the intruder 5 is barred by a door barricade system, which is broadly designated by the reference number 10. More specifically, the door barricade system 10 is deployed between the door 1 and floor 9. The disclosure is not limited to the exemplary barricade system 10 that prevents the door 1 from being opened into the classroom 3. For instance, another embodiment shown in FIGS. 11 and 12 will prevent a door from being pulled open.

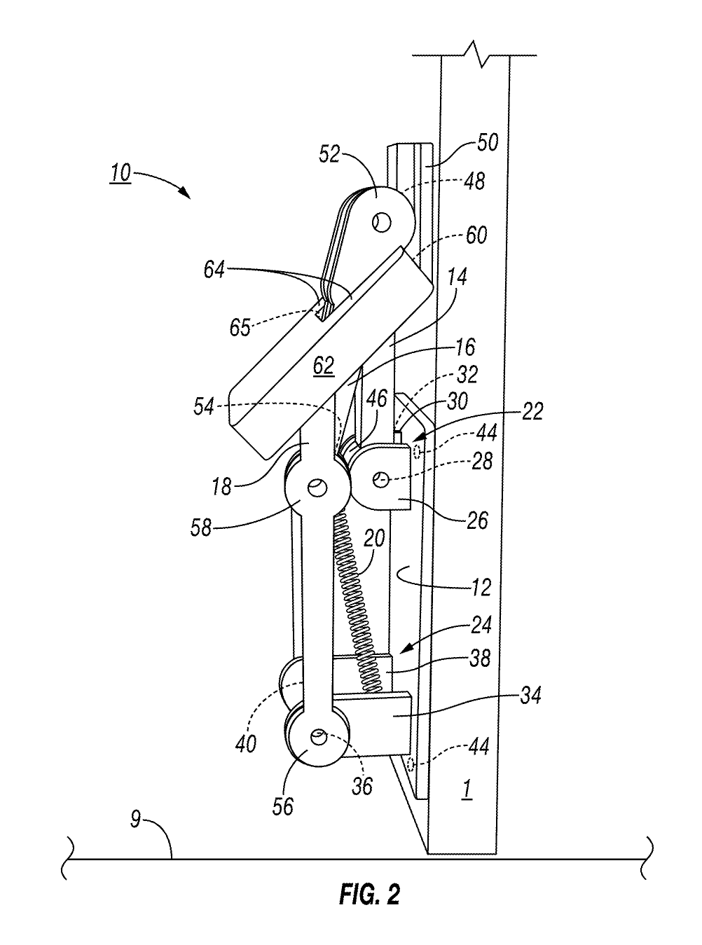

With reference to FIG. 2 the door barricade system 10 is most clearly shown installed on the door 1 above the floor 9 in a first or retracted state. As shown, the barricade system 10 may include a mounting plate or base 12, a first stanchion, leg or leg set 14, a second stanchion, leg or leg set 16, a third stanchion, leg or leg set 18, and a tension device or spring 20. A first connector, joint or knuckle 22 may be unitary part of or attached to or connected with the base 12, which itself may be connected to the door 1 via attachment apertures 44 for screws, bolts, or the like. More particularly, the first leg 14 is shown in a first state or retracted position rotatably connected within or between a first shoulder or panel 26 and a second shoulder or panel 30 of the first joint 22. In this example, the first panel 26 and the second panel 30 have respective pivot apertures 28, 32 to receive a first rotator, axle, fulcrum, hinge, or rotation end 46 of the first leg 14. Spaced apart from the rotation end 46 is a second axle, fulcrum, rotator or rotation end 48 attached to or carrying a foot plate 50, also called a pressure or locking plate or pedal, which will be explained by exemplary operation below.

FIG. 2 further shows the second leg 16 being held in the first or retracted state or position by the spring 20. The second leg 16 has opposing ends; i.e., a third hinge, fulcrum, or rotator 52 and a fourth fulcrum or rotator 54. The third rotator 52 will interact with, swivel, or rotate relative to the rotation end 48 of the first leg 14 when the second leg 16 is in a second, deploying, or intermediate state as it transitions to a third state, also referred to as a locked, deployed, extended, final, or operational state. The fourth rotator 54 will likewise interact with, swivel, or rotate relative to the rotation end 46 of the first leg 14 when the second leg 16 is in the second state or transitioning to the third locked state.

Also shown in FIG. 2 is a second connector, joint or knuckle 24 that may be a part of or connected to the base 12. Here, the third leg 18 is shown in a first state or retracted position rotatably connected within, between, about or outside of a third shoulder or panel 34 and a fourth shoulder or panel 38 of the second joint 24. More particularly, a fifth fulcrum or rotator 56 of the third leg 18 is swivably attached to the panels 34, 38 via respective apertures 36, 40 using, for instance, pin joints or other moving mechanical assemblies. Still further, the third leg 18 may include a sixth fulcrum or rotator 58 rotatably attached to the fourth rotator 54. At or near the sixth rotator 58 is a stand or foot 60 that may include a boot, pad, or shoe 62 made of rubber or other non-skid, elastomeric material. In this example, the foot 60 and the shoe 62 may include split toes or sections 64 that form a slot or gap 65, which in the retracted state shown, receives a portion of the legs 14, 16 to provide a compact or low profile for storage in the retracted state. The rubber shoe 62 may be formed with treads as desired; however, a solid flat surface of the non-skid shoe 62 as shown provides the greatest surface area for contact with the floor 9, which creates a high coefficient of friction to prevent the foot 60 and the shoe 62 from sliding across the floor 9 when the door barricade system 10 is in the third deployed state, as further explained below.

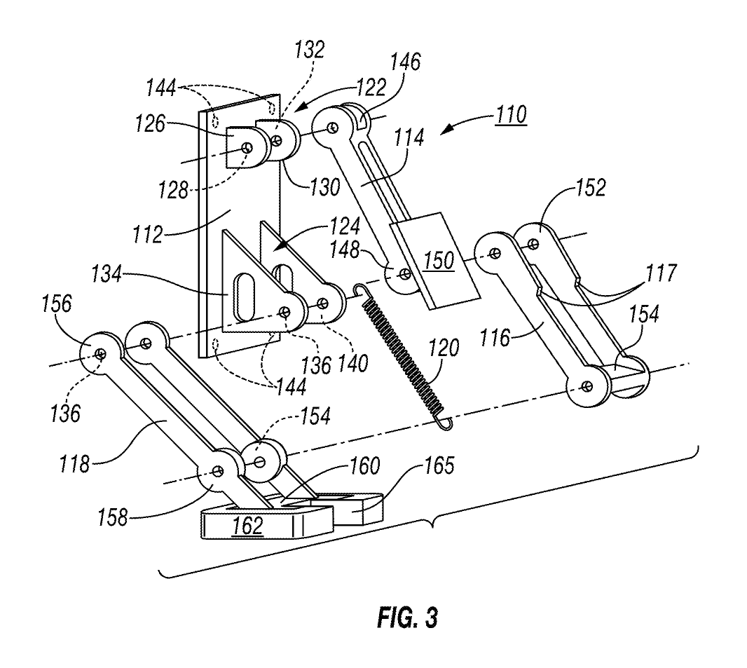

Turning to FIG. 3, components of another embodiment of the disclosure are shown separated from each other for clarity. Here, a door barricade system 110 is to be installed on a door at a desired distance or height above a floor. As shown, the barricade system 110 may include a plate or base 112, a first leg or leg set 114, a second leg or leg set 116, a third leg or leg set 118, and a tension device or spring 120. A first connector, joint or knuckle 122 may be attached or connected with the base 112, which itself may be connected to the door via attachment apertures 144 for screws, bolts, or the like. More particularly, the first leg 114 is shown for rotatable or swivel connection within or between a first shoulder or panel 126 and a second shoulder or panel 130 of the first joint 122. In this example, the first panel 126 and the second panel 130 have respective pivot apertures 128, 132 to receive a first fulcrum, rotator or rotation end 146 of the first leg 114. Spaced apart from the rotation end 146 is a second fulcrum, rotator or rotation end 148 having a pressure or locking plate end 150, which will be explained by exemplary operation below.

FIG. 3 further shows the second leg 116 with a third fulcrum or rotator 152 and a fourth fulcrum or rotator 154. Here, the third rotator 152 will interact with or rotate relative to the rotation end 148 of the first leg 114 when the second leg 116 is in a second, deploying or intermediate state as it transitions to a third, deployed, or extended and locked state. The fourth rotator 154 will likewise interact with or rotate relative to a rotation end 158 of the third leg 118 when the second leg 116 is in the second state or transitioning to the third locked state. Also in this exemplary embodiment, one or more ridges or ledges 117 are disposed between the third rotator 152 and the fourth rotator 154, which serve to stop the locking plate 150 and to lock the legs 114, 116 at approximately one-hundred and seventy-eight degrees (178°), as explained in more detail below.

Also shown in FIG. 3 is a second connector, joint or knuckle 124 that may be attached or connected with the base 112. Here, the third leg 118 is shown for rotatable connected within, between, about or outside a third shoulder or panel 134 and a fourth shoulder or panel 138 of the second joint 124. More particularly, a fifth fulcrum or rotator 156 of the third leg 118 is swivably attached to the panels 134, 138 via respective apertures 136, 140 using, for instance, pin joints or other mechanical joints. Still further, the third leg 118 may include the sixth fulcrum or rotator 158 for rotatable attachment to the fourth rotator 154. At or near the sixth rotator 158 is a non-skid stand or foot 160 that may include a boot, pad, or shoe 162 made of rubber or other non-skid material to induce friction, to oppose sliding, and to resist door opening. In this example, the foot 160 and the shoe 162 may include split toes or sections 164 that form a slot or gap 165 to receive a portion of the legs 114, 116 to provide a compact or low profile for storage in a folded or retracted state.

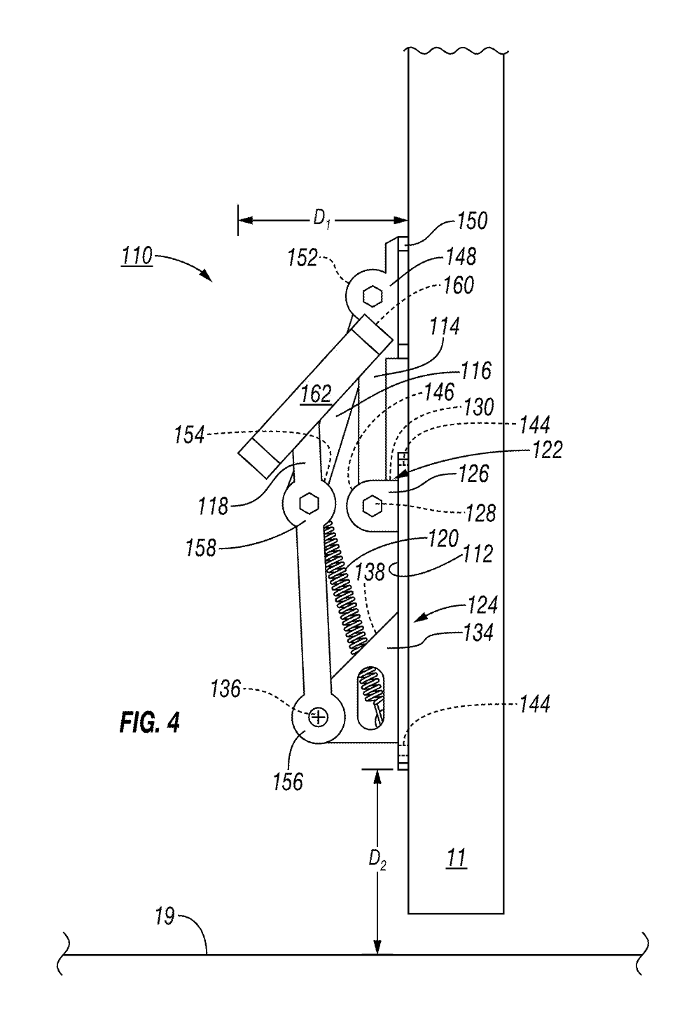

FIG. 4 shows that the barricade system 110 may be attached to a bottom portion of a door 11 and is shown here in the first or retracted state. The folded system 110 has a low or compact profile as indicated by a first profile or standoff distance D1. In this first state the folded system 110 has a limited protuberance profile so as to not interfere with normal foot traffic. For example, the standoff distance D1 may extend from about two inches (2″) to about twelve inches (12″), more particularly, about six inches (6″) from a vertical surface of the door 11.

FIG. 4 further shows that the barricade system 110 may be installed on the lower portion of the door 11 above floor 19 at a second profile or distance D2. The distance D2 is sufficient to accommodate the barricade system 110 when unfolded and deployed into the operational or locked state. For instance, if the leg 116 of the barricade system 110 is six inches (6″) in length, then the distance D2 should be approximately four inches (4″) but may be approximately ten inches (10″), more particularly, six inches (6″) to eight inches (8″) in length, depending on an overall deployed length of the legs 114, 116, 118, in order for the barricade system 110 to deploy to its fully locked third state.

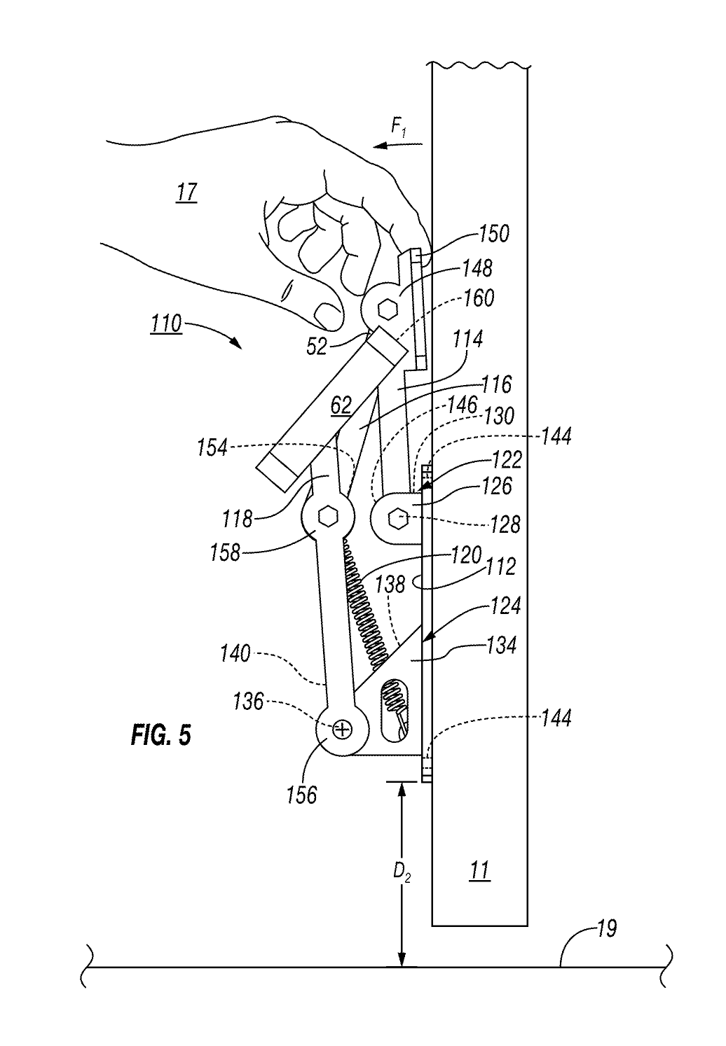

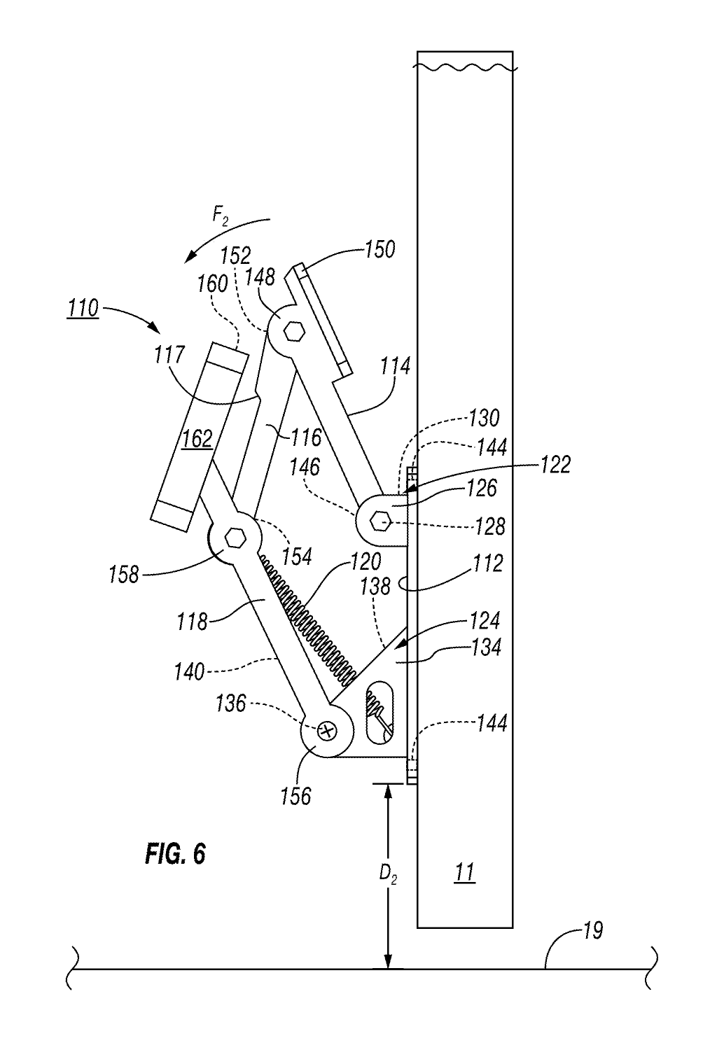

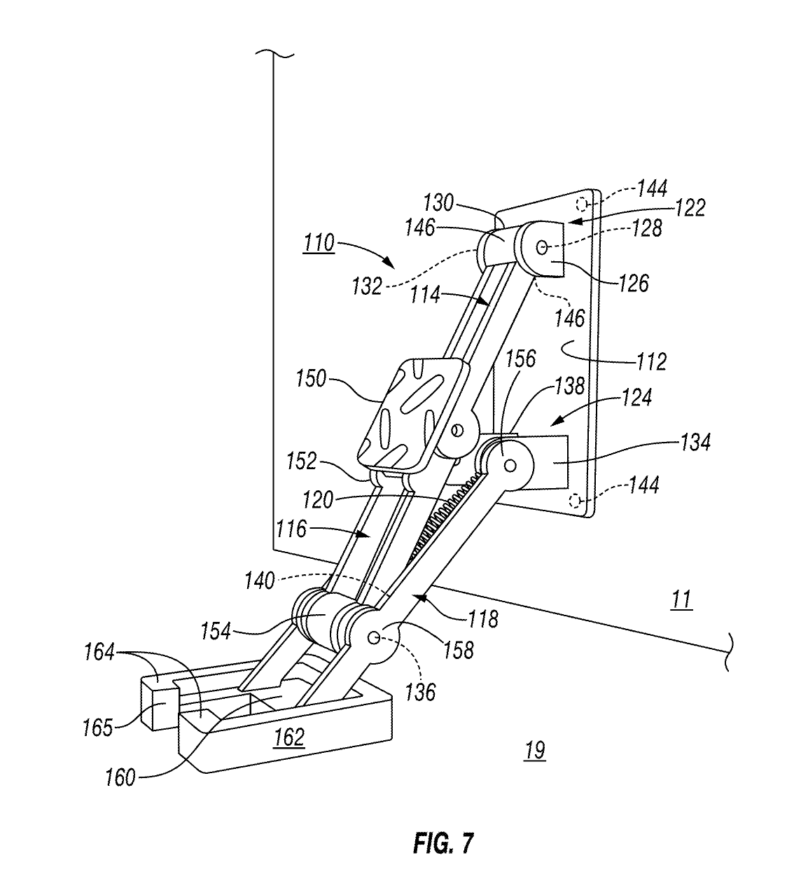

Turning to FIGS. 5, 6, 7, 8, and 9, the system 110 introduced in FIGS. 3 and 4 is deployed by way of example operation. As shown, for instance, in FIG. 5 a person 17—upon being alerted of an intruder—activates the system 110 by pulling at or near the plate 150 in an outward direction with sufficient force F1 to release the locking plate 150 from near the door 11 and/or to overcome the spring constant of the spring 120. As shown in FIG. 6, gravity begins to take over and the weight of the barricade system 110 causes the system 110 to begin dropping in a direction with force F2 toward the ground 19, although gravity and the spring 120 will not take over fully until the spring 120 is disposed approximately horizontal or parallel to the floor 19. FIG. 7 shows the system 110 in a prelocked state or condition with the rubber boot 162 in contact with the floor 19.

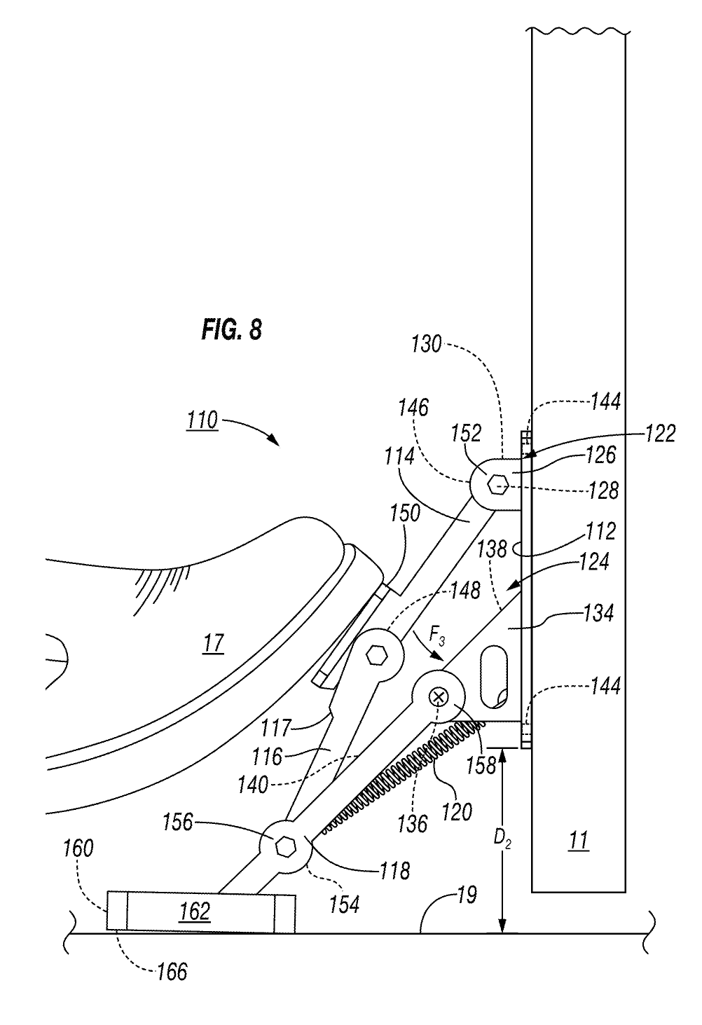

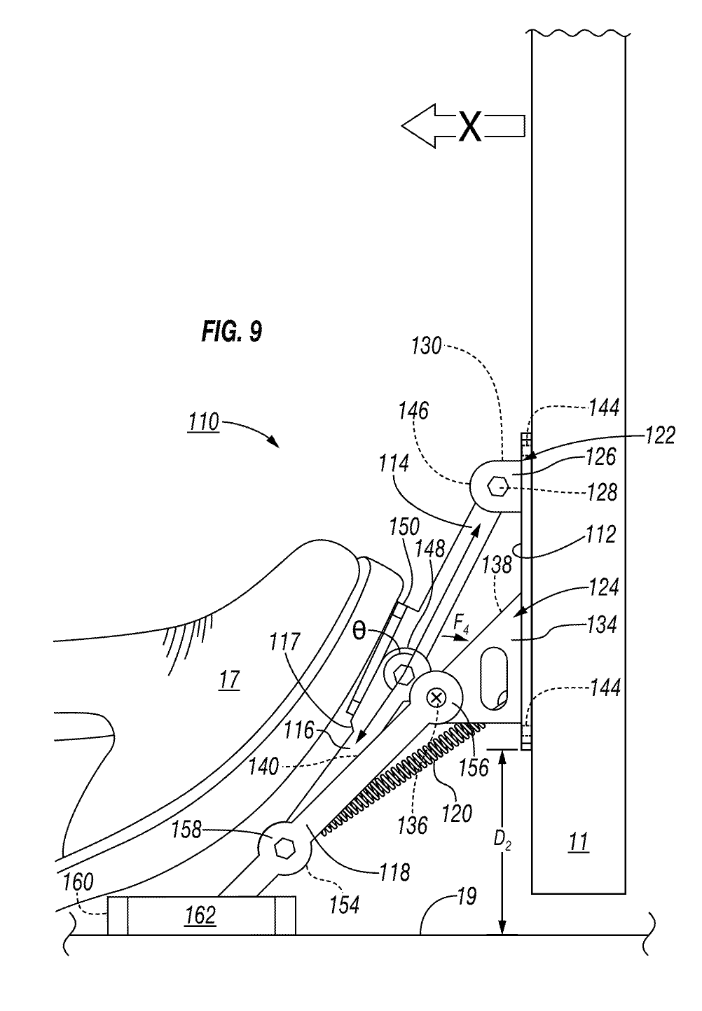

With particular reference to FIG. 8, the stand 160 and its rubber shoe 162 are shown not flush with or completely engaged against the floor 19, as indicated by a gap 166. Therefore, the person 17 will press or step on the foot plate or pressure plate 150, which will push the legs 114, 116 toward the door 11 with direction and force F3. This over-center locking arrangement between the legs 114, 116 provides a minimal initial downward force necessary to cause binding and engage a self-amplifying or compounding force system. Once locked, as further explained with respect to FIG. 9 below, the self-actuating system also prevents upward movement of the barricade 110 that may normally be caused by jarring impact.

FIG. 9 shows that once the person 17 has pressed the plate 150 toward the door 11, an angle between the legs 114, 116 passes one hundred and eighty degrees (180°) relative to the legs 114, 116; i.e., the legs 114, 116 are not aligned, and an obtuse angle θ is formed between and by the legs 114, 116 stopping at between about one hundred and seventy-five degrees (175°) to about one hundred and seventy-nine degrees (179°), more particularly about one hundred and seventy-eight degrees (178°), due to a shape of the leg 116 and from contact by the foot plate 150 against the leg 116 upon which the foot plate 150 must rest. More particularly, as introduced with respect to FIG. 3 above, the ledges 117 of the leg 116 serve to stop the plate 150 and to lock the legs 114, 116 at approximately one-hundred and seventy-eight degrees (178°) relative to each other. Moreover, as shown in the engaged or locked state of FIG. 9, the gap 166 between the rubber shoe 162 and the floor 19 shown in FIG. 8 has been closed as the rubber shoe 162 is now hard pressed against the floor 19.

A crossed-out arrow schematically indicates in FIG. 9 that pushing from an opposite side of the door 11 is insufficient to overcome the large coefficient of friction created by the non-skid stand 160 being pressed down against the floor 19 and the obtuse angle θ of the deployed barricade system 110. More particularly, after the non-skid stand 160 and/or rubber shoe 162 is pressed against the floor 19, if an assailant presses on or pushes against the door 11, the barricade system 110 locks or binds against itself; i.e., it is a self-amplifying force system that causes the pushed door 11 to flex, which results in a downward force vector further pressing the shoe 162 against the floor 19. Accordingly, the harder the assailant pushes against the door 11, the greater the resulting binding of the shoe 162 to the floor 19. Stated yet another way, the over-center locking arrangement shown in FIG. 9 proximate angle θ provides an initial downward force to engage the self-amplifying force system 110 against the floor 11, which is then amplified or compounded when someone is attempting to push on the door 11. This self-amplifying arrangement also prevents upward movement of the barricade 110 that might be caused by a jarring impact.

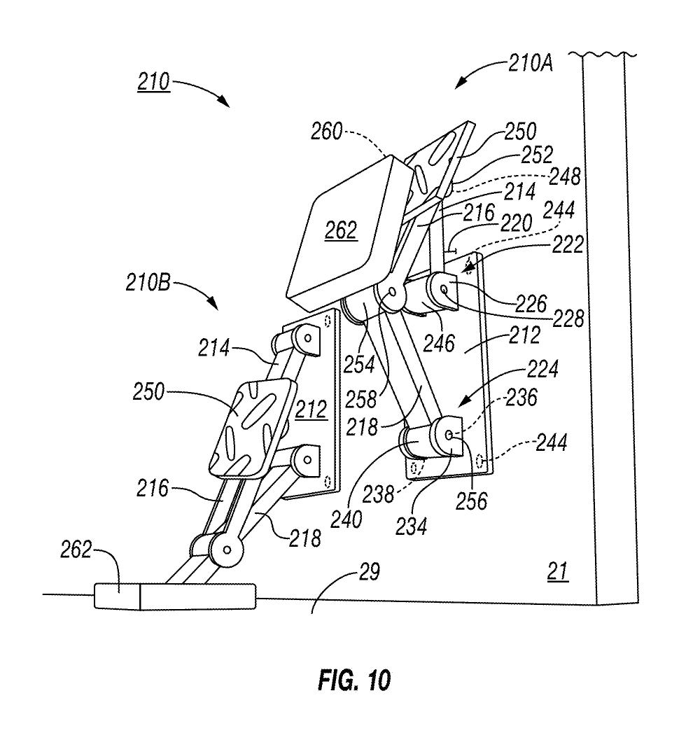

According to another aspect of the present disclosure shown in FIG. 10, a door barricade or blockade system is designated in general by the reference number 210. Here, at least two door barricade systems 210A, B are installed on a door 21 at a predetermined distance or height above a floor 29, more particularly about three inches (3″) to about six inches (6″). As shown, each of the barricade systems 210A, B may include a plate or base 212, a first leg or leg set 214, a second leg or leg set 216, a third leg or leg set 218, and a release mechanism such as a quick release latch, hook, or switch 220. A first connector, joint or knuckle 222 may be attached or connected with the base 212, which itself may be connected to the door via attachment apertures 244 for screws, bolts, or the like. More particularly, each first leg 214 is shown for rotatable or swivel connection within or between a first shoulder or panel 226 and a second shoulder or panel 230 of the first joint 232. In this example, the first panel 226 and the second panel 230 have respective pivot apertures 228, 232 to receive a first rotator or rotation end 246 of the first leg 214. Spaced apart from the rotation end 246 is a second rotator or rotation end 248 having a pressure or locking plate end 250.

FIG. 10 further shows that a second leg 216 may have a third rotator 252 and a fourth rotator 254. The third rotator 252, once the quick release latch 220 is released, will interact with or rotate relative to the rotation end 248 of the first leg 214 when the second leg 216 is in a second, deploying or intermediate state as it transitions to a third, deployed, or extended and locked state (compare raised or stored barricade system 210A to deployed barricade system 210B). The fourth rotator 254 will likewise interact with or rotate relative to the rotation end 246 of the first leg 214 when the second leg 216 is in the second state or transitioning to the third locked state.

Also shown in FIG. 10 is a second connector, joint or knuckle 224 that may be attached or connected with the base 212. Here, the third leg 218 is shown for rotatable connected within, between, about or outside a third shoulder or panel 234 and a fourth shoulder or panel 238 of the second joint 224. More particularly, a fifth rotator 256 of the third leg 218 is swivably attached to the panels 234,238 via respective apertures 236,240 using, for instance, pin joints or other mechanical joints. Still further, the third leg 218 may include a sixth rotator 258 for rotatable attachment to the fourth rotator 254. At or near the sixth rotator 258 is a stand or foot 260 that may include a boot or shoe 262 made of rubber or other non-skid material.

Turning now to FIGS. 11 and 12, another embodiment of a door barricade system is generally indicated by element number 310 and is installed on a door 312 at a desired distance or height above a floor 39. As shown, the barricade system 310 may include a plate or base 312, a first leg, stanchion, or leg set 314, a second leg, stanchion, or leg set 316, a third leg, stanchion, or leg set 318, and a tension device or spring 320. A first connector, joint or knuckle 322 may be attached or connected with the base 312, which itself may be connected to the door via attachment apertures 344 for screws, bolts, or the like. More particularly, the first leg 314 is shown for rotatable or swivel connection within or between a first shoulder or panel 326 and a second shoulder or panel 330 of the first joint 322. In this example, the first panel 326 and the second panel 330 have respective pivot apertures 328, 332 to receive a first rotator or fulcrum end 346 of the first leg 314. Spaced apart from the rotation end 346 is a second rotator or fulcrum end 348 having a pressure or locking plate end 350 that can be pressed in a second or transitioning state to lock the barricade system 310 in a third or locked state.

FIGS. 11 and 12 further show the second leg 316 with a third fulcrum or rotator 352 and a fourth fulcrum or rotator 354. The third rotator 352 will interact with or rotate relative to the rotation end 348 of the first leg 314 when the second leg 316 is in a second, deploying or intermediate state as it transitions to the third, deployed, or extended and locked state. The fourth rotator 354 will likewise interact with or rotate relative to the rotation end 358 of the third leg 318 when the second leg 316 is in the second state or transitioning to the third locked state. Also in this exemplary embodiment, one or more ridges or ledges 317 are disposed between the third rotator 352 and the fourth rotator 354, which serve to stop the locking plate 350 and to lock the legs 314, 316 at approximately one-hundred and seventy-eight degrees (178°), as explained in more detail below.

Also shown in FIGS. 11 and 12 is a second connector, joint or knuckle 324 that may be attached or connected with the base 312. Here, the third leg 318 is shown for rotatable connected within, between, about or outside a third shoulder or panel 334 and a fourth shoulder or panel 338 of the second joint 324. More particularly, a fifth fulcrum or rotator 356 of the third leg 318 is swivably attached to the panels 334, 338 via respective apertures 336, 340 using, for instance, pin joints or other mechanical joints. Still further, the third leg 318 may include a sixth fulcrum or rotator 358 for rotatable attachment to the fourth rotator 354. At or near the sixth rotator 358 is a non-skid stand or foot 360 that may include a boot, pad, or shoe 362 made of rubber or other non-skid material. In this example, the foot 360 and the complementary pad 362 may include split toes or sections 364 that form a slot or gap 365 to receive a portion of the legs 314, 316 to provide a compact or low profile for storage in a folded or retracted state. Also in this example, if in boot form, the non-skid 362 may fit over the foot 360. Alternatively, if in pad form, the non-skid 362 may be glued, heat-welded, snap-fitted or otherwise adhered to the foot 360.

FIG. 11 particularly shows that in a locked state, the foot 360 is inverted or facing toward the door 31, which in this example, opens outward or away from a room to which it provides entrance. Accordingly, when the door barricade system 310 is deployed and activated by the pressure plate 350, the door 31 cannot be pulled open as schematically indicated by the crossed-out arrow.

FIG. 12 more particularly shows that the foot 360 is angled away from the third stanchion 318 to face toward the door 31. In this example, the foot 360 forms an angle θ of between about forty-five degrees (45°) to about sixty-five degrees (65°), more particularly about sixty degrees (60°) relative to the floor 39. Accordingly, when the door barricade system 310 is deployed and activated by locking the pressure plate 350 (i.e., pushing toward the door 31), the door 31 resists being pulled open. Here, the over-center, locking arrangement of the locked legs 314, 316 provides a self-amplifying or compounding force. Specifically, as an assailant pulls on the door 31 in a direction P1, the legs 314, 316 are pushed against each other in a direction P2, which in turn presses the foot 360 in a downward direction P3. More particularly, the plate 350 is stopped at ridges 317 and a leading portion of the foot 360 closest to the door 31 is pressed downward with even greater force into the floor 49. Stated yet another way, the harder the assailant pulls in the direction P1, the greater the resulting downward force P3 and resulting friction due to a rotational or clockwise force in the self-actuating embodiment shown in FIG. 12.

### EXEMPLARY EMBODIMENTS

### Embodiment 1

A door barricade system, comprising a mounting plate connectable to a door; a first leg having a first proximal end and a first distal end, the first proximal end being connectable to and rotatable relative to the mounting plate, the first leg being configured for a stored state, a transitioning state, and a deployed state; a second leg having a second proximal end and a second distal end, the second proximal end being rotatably connected to first distal end of the first leg, the second leg being configured to be in the stored state, the transitioning state, and the deployed state; a third leg having a third proximal end and a third distal end, the third proximal end being connectable to and rotatable relative to the mounting plate, the third distal end being rotatably connected to second distal end of the second leg, the third leg being configured to be in the stored state, the transitioning state, and the deployed state; and a non-skid stand attached to the third leg, the non-skid stand being engaged against a surface proximate the door when the first, second and third legs are in the deployed state, the first leg and the second leg being lockable against each other proximate a ledge disposed on the second leg and further configured to press the non-skid stand into the surface as a force is applied against the door.

### Embodiment 2

The door barricade system of embodiment 1, wherein the mounting plate, the first leg, the second leg, the third leg and the non-skid stand, when in the stored state, define a compact profile.

### Embodiment 3

The door barricade system of embodiment 2, wherein the compact profile is from between about 2 inches to about 6 inches, more particularly about 3 inches, from the door.

### Embodiment 4

The door barricade system of embodiments 1-3, wherein the mounting plate is mounted to the door at a minimum height above the surface for the system to engage in the deployed state.

### Embodiment 5

The door barricade system of embodiment 4, wherein the minimum height is from between about 3 inches to about 6 inches between a bottom of the mounting plate and the surface.

### Embodiment 6

The door barricade system of any of the foregoing embodiments, wherein the non-skid stand includes a slot formed therein to receive a portion of the first leg or the second leg.

### Embodiment 7

The door barricade system of any of the foregoing embodiments, further comprising a release mechanism configured to deploy the first leg, the second leg, the third leg and the non-skid stand in a direction away from the mounting plate.

### Embodiment 8

The door barricade system of any of the foregoing embodiments, further comprising a friction-inducing cover for the non-skid stand.

### Embodiment 9

The door barricade system of any of the foregoing embodiments, further comprising a spring attached between the mounting plate and non-skid stand for urging the first leg, the second leg, the third leg and the non-skid stand to remain in the stored state.

### Embodiment 10

The door barricade system of any of the foregoing embodiments, further comprising a plate for urging the first leg and the second leg to form an obtuse angle in the deployed state.

### Embodiment 11

The door barricade system of embodiment 10, wherein the plate is configured to lock the first leg and the second leg in the deployed state, the locked first and second legs cooperating with the non-skid stand in the deployed state to oppose an opening of the door.

### Embodiment 12

A door barricade system, comprising a first leg having a first proximal end and a first distal end, the first proximal end being connectable to and rotatable relative to a door, the first leg being configured for a stored state, a transitioning state, and a deployed state; a second leg having a second proximal end and a second distal end, the second proximal end being rotatably connected to first distal end of the first leg, the second leg being configured to be in the stored state, the transitioning state, and the deployed state; a third leg having a third proximal end and a third distal end, the third proximal end being connectable to and rotatable relative to the door, the third distal end being rotatably connected to second distal end of the second leg, the third leg being configured to be in the stored state, the transitioning state, and the deployed state; and a non-skid stand attached to the third leg, the non-skid stand having a slot formed therein to receive a portion of the first leg or the second leg, the non-skid stand being engageable against a surface proximate the door when the first, second and third legs are in the deployed state.

### Embodiment 13

The door barricade system as in embodiment 12, further comprising a release mechanism configured to deploy the first leg, the second leg, the third leg and the non-skid stand in a direction away from the door.

### Embodiment 14

The door barricade system as in embodiments 12-13, wherein the non-skid stand is substantially aligned with the third leg in the transitioning state.

### Embodiment 15

The door barricade system as in any one of embodiments 12-14, wherein the non-skid stand is disposed at an angle relative to the third leg in the deployed state.

### Embodiment 16

The door barricade system as in any one of embodiments 12-15, wherein, in the deployed state as an opening force is applied to the door, the first leg and the second leg lock against each other and further press the non-skid stand into the surface.

### Embodiment 17

The door barricade system as in any one of embodiments 12-16, further comprising an elastomeric cover for the non-skid stand.

### Embodiment 18

The door barricade system as in any one of embodiments 12-17, further comprising a spring mechanism attached between the door and the non-skid stand for urging the first leg, the second leg, the third leg and the non-skid stand to remain in the stored state.

### Embodiment 19

The door barricade system as in any one of embodiments 12-18, further comprising a plate for urging the first leg and the second leg to form an obtuse angle in the deployed state.

### Embodiment 20

The door barricade system as in any one of embodiments 12-19, further comprising a mounting base connectable to a door, the mounting base being interposed between the door and the first leg and the third leg.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

That which is claimed is:

1. A door barricade system, comprising:
a mounting plate connectable to a door;
a first leg having a first proximal end and a first distal end, the first proximal end being connectable to and rotatable relative to the mounting plate, the first leg being configured for a stored state, a transitioning state, and a deployed state;
a second leg having a second proximal end and a second distal end, the second proximal end being rotatably connected to first distal end of the first leg, the second leg being configured to be in the stored state, the transitioning state, and the deployed state;
a third leg having a third proximal end and a third distal end, the third proximal end being connectable to and rotatable relative to the mounting plate, the third distal end being rotatably connected to second distal end of the second leg, the third leg being configured to be in the stored state, the transitioning state, and the deployed state; and
a non-skid stand attached to the third leg, the non-skid stand being engaged against a surface proximate the door when the first, second and third legs are in the deployed state, the first leg and the second leg being lockable against each other proximate a ledge disposed on the second leg and further configured to press the non-skid stand into the surface as a force is applied against the door.

2. The door barricade system as in claim 1, wherein the mounting plate, the first leg, the second leg, the third leg and the non-skid stand, when in the stored state, define a compact profile.

3. The door barricade system as in claim 2, wherein the compact profile is from between about 2 inches to about 6 inches from the door.

4. The door barricade system as in claim 1, wherein the mounting plate is mounted to the door at a minimum height above the surface for the system to engage in the deployed state.

5. The door barricade system as in claim 4, wherein the minimum height is from between about 3 inches to about 6 inches between a bottom of the mounting plate and the surface.

6. The door barricade system as in claim 1, wherein the non-skid stand includes a slot formed therein to receive a portion of the first leg or the second leg.

7. The door barricade system as in claim 1, further comprising a release mechanism configured to deploy the first leg, the second leg, the third leg and the non-skid stand in a direction away from the mounting plate.

8. The door barricade system as in claim 1, further comprising a friction-inducing cover for the non-skid stand.

9. The door barricade system as in claim 1, further comprising a spring attached between the mounting plate and non-skid stand for urging the first leg, the second leg, the third leg and the non-skid stand to remain in the stored state.

10. The door barricade system as in claim 1, further comprising a plate for urging the first leg and the second leg to form an obtuse angle in the deployed state.

11. The door barricade system as in claim 10, wherein the plate is configured to lock the first leg and the second leg in the deployed state, the locked first and second legs cooperating with the non-skid stand in the deployed state to oppose an opening of the door.

12. A door barricade system, comprising:
a first leg having a first proximal end and a first distal end, the first proximal end being connectable to and rotatable relative to a door, the first leg being configured for a stored state, a transitioning state, and a deployed state;
a second leg having a second proximal end and a second distal end, the second proximal end being rotatably connected to first distal end of the first leg, the second leg being configured to be in the stored state, the transitioning state, and the deployed state;
a third leg having a third proximal end and a third distal end, the third proximal end being connectable to and rotatable relative to the door, the third distal end being rotatably connected to second distal end of the second leg, the third leg being configured to be in the stored state, the transitioning state, and the deployed state; and
a non-skid stand attached to the third leg, the non-skid stand having a slot formed therein to receive a portion of the first leg or the second leg, the non-skid stand being engageable against a surface proximate the door when the first, second and third legs are in the deployed state.

13. The door barricade system as in claim 12, further comprising a release mechanism configured to deploy the first leg, the second leg, the third leg and the non-skid stand in a direction away from the door.

14. The door barricade system as in claim 12, wherein the non-skid stand is substantially aligned with the third leg in the transitioning state.

15. The door barricade system as in claim 12, wherein the non-skid stand is disposed at an angle relative to the third leg in the deployed state.

16. The door barricade system as in claim 12, wherein, in the deployed state as an opening force is applied to the door, the first leg and the second leg lock against each other and further press the non-skid stand into the surface.

17. The door barricade system as in claim 12, further comprising an elastomeric cover for the non-skid stand.

18. The door barricade system as in claim 12, further comprising a spring mechanism attached between the door and the non-skid stand for urging the first leg, the second leg, the third leg and the non-skid stand to remain in the stored state.

19. The door barricade system as in claim 12, further comprising a plate for urging the first leg and the second leg to form an obtuse angle in the deployed state.

20. The door barricade system as in claim 12, further comprising a mounting base connectable to a door, the mounting base being interposed between the door and the first leg and the third leg.
